(19) United States
(12) Patent Application Publication
(10) Pub. No.: US 2026/0340702 A1
(43) Pub. Date: Oct. 29, 2026

(54) System and Method for Personalized Fragrance Recommendations

(71) Applicants: Samhitha Sai Yennam, San Ramon, CA (US); Srinivasa Rao Yennam, San Ramon, CA (US)

(72) Inventors: Samhitha Sai Yennam, San Ramon, CA (US); Srinivasa Rao Yennam, San Ramon, CA (US)

(21) Appl. No.: 19/188,203

(22) Filed: Apr. 24, 2025

(51) Int. Cl. G06Q 30/0601

(52) U.S. Cl. CPC G06Q 30/0631; G06Q 30/0641

(57) ABSTRACT

Disclosed is a system and method for personalized fragrance recommendations using artificial intelligence (AI), dynamic barcode-based profiling, and real-time data adaptation. The system receives user preference data via a graphical user interface (GUI) and generates a digital scent profile identifier (Personal Barcode). The AI engine matches the Personal Barcode with dynamically updated fragrance product profiles (Product Barcodes) stored in a database. The system continuously learns from user interactions, purchase behaviour, and global fragrance trends, dynamically updating both user profiles and product attributes to enhance accuracy.

### TECHNICAL FIELD

The present invention relates to the field of personalized recommendation systems, and more particularly, to a system and method for providing personalized fragrance recommendations based on user preferences, artificial intelligence (AI)-driven analysis, and dynamic fragrance profiling.

### BACKGROUND

The fragrance industry has long relied on sensory experiences to drive consumer purchasing decisions. In physical retail stores, customers can test perfumes directly, evaluating factors such as scent composition, intensity, and longevity before making a purchase. However, with the rise of e-commerce, consumers increasingly face challenges in selecting fragrances online due to the inability to physically experience scents. Unlike other product categories where specifications and images provide sufficient information for decision-making, fragrance shopping is inherently subjective, relying on personal preferences, moods, and occasions. As a result, online shoppers often struggle with uncertainty, leading to hesitation in purchasing, increased return rates, and reduced consumer confidence in digital fragrance selection.

Conventionally, e-commerce platforms have implemented basic recommendation systems that suggest fragrances based on general attributes, such as fragrance family, customer reviews, or purchase history. Some platforms provide simple scent quizzes that categorize preferences into broad groups, while others use static filtering methods to sort products by scent type, season, or brand. Additionally, high-end retailers have experimented with virtual try-on tools that leverage textual descriptions or AI-driven predictions. While these methods offer some level of guidance, they often fail to capture the complexity of personal fragrance preferences and lack adaptability to changing user tastes.

The limitations of traditional approaches stem from their lack of personalization, adaptability, and real-time user interaction. Static filtering and scent quizzes rely on generic assumptions rather than individualized user profiles, making recommendations less precise. Existing AI-powered systems typically base predictions on limited data points such as purchase history, failing to consider emotional and lifestyle factors that influence scent preferences. Furthermore, these systems do not evolve dynamically with global fragrance trends or user feedback, leading to outdated or irrelevant recommendations.

In light of the above-mentioned problems associated with existing methods for digital fragrance shopping, an innovative solution is required that bridges sensory engagement with AI-driven personalization.

### SUMMARY

Embodiments of the present disclosure present technological improvements as solutions to one or more of the above-mentioned technical problems recognized by the inventor in conventional solutions.

The present invention discloses a system and method for personalized fragrance recommendations using artificial intelligence (AI) and dynamic barcode-based profiling. The method begins by collecting user preference data through a questionnaire covering multiple fragrance profiling categories, such as scent style, mood, and longevity. A digital scent profile identifier (Personal Barcode) representing the user's unique olfactory preferences is generated. A database stores product profiles (Product Barcodes), which dynamically update in real time based on global user feedback. An AI engine matches the Personal Barcode with Product Barcodes by performing similarity analysis, weighted scoring, and adaptive learning. Based on the barcode-matching results, personalized fragrance recommendations are generated and displayed via a graphical user interface, where color-coded visual representations indicate key fragrance attributes.

Additional aspects, advantages, features and objects of the present disclosure would be made apparent from the drawings and the detailed description of the illustrative embodiments construed in conjunction with the complete specification that will follow.

It will be appreciated that features of the present disclosure are susceptible to being combined in various combinations without departing from the scope of the present disclosure.

### BRIEF DESCRIPTION OF DRAWINGS

The summary above, as well as the following description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts an exemplary system for generating personalized fragrance recommendations as per the present disclosure.

FIG. 2 depicts an example product profile page 200 related to a fragrance

FIG. 3 is a flowchart depicting the method steps of the invention

It will be appreciated that the drawings illustrated herein are for representation purposes only and do not intend to limit the scope of the present disclosure, and actual implementation of the present disclosure may be viewed substantially differently.

### DESCRIPTION OF EMBODIMENTS

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The invention provides a system and method for personalized fragrance recommendations that leverage artificial intelligence (AI), dynamic barcode-based profiling, and real-time user analytics to replicate the intuitive decision-making process of in-store fragrance selection. By generating a Personal Barcode based on user preferences and matching it against dynamically evolving Product Barcodes, the system ensures that recommendations are highly personalized and continuously updated in response to individual user inputs and global fragrance trends. The invention addresses the technical problem of accurately replicating sensory-based decision-making in a digital environment, specifically for fragrance selection in e-commerce platforms. Traditional online fragrance shopping lacks the ability to convey scent characteristics, leading to consumer uncertainty, high return rates, and limited engagement. Existing recommendation systems rely on static filters, broad scent categories, or basic AI models that fail to dynamically adapt to user preferences, evolving fragrance trends, and real-time feedback. This invention solves this problem by introducing a computational system that utilizes AI-driven barcode-based profiling to map user scent preferences and match them with dynamically updated product profiles. By employing real-time data analytics, machine learning algorithms, and weighted similarity scoring, the system enables precise, context-aware fragrance recommendations that evolve over time. Additionally, the invention provides a structured approach to quantifying fragrance attributes, translating subjective olfactory characteristics into objective digital representations. This ensures that personalization is data-driven, adaptive, and scalable across e-commerce platforms, solving the technical limitations of existing static and rule-based recommendation engines.

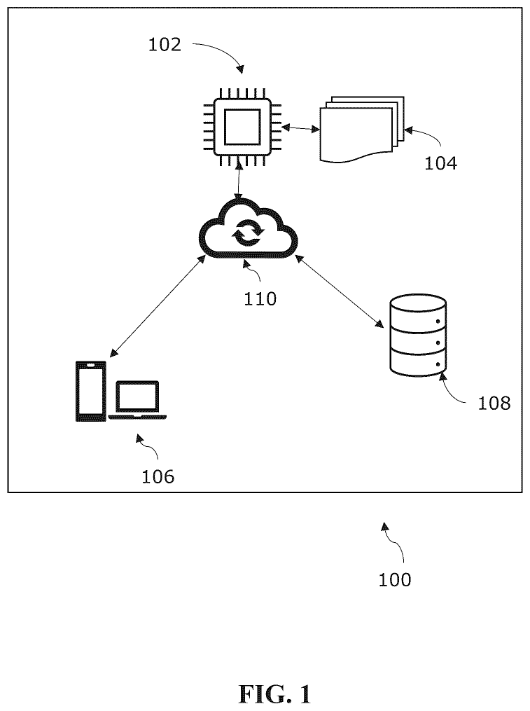

FIG. 1 depicts an exemplary system 100 as per the present disclosure. The system 100 comprises a processor 102 communicably coupled to a memory 104 and a graphical user interface 106 associated with a user client. The processor 102 captures user inputs via a questionnaire displayed on the graphical user interface 106. The processor 102 converts user input into a Personal Barcode and matches Personal Barcodes with Product Barcode. The processor 102 performs similarity analysis, refines recommendations and provides personalized suggestions. The system further comprises a database 108 that stores fragrance profiles in form of Product Barcodes and dynamically updates them. The processor 102 is further communicably coupled to the graphical user interface 106 and third-party e-commerce platforms through one or more data communication networks 110.

The processor 102 is configured to store product profiles for a plurality of fragrances in a database 108, ensuring real-time adaptability and dynamic updates based on global user feedback and evolving fragrance trends. Each product profile is structured as a Product Barcode, a unique digital signature representing the characteristics of a fragrance, dynamically evolving based on aggregated user interactions, purchase patterns, and AI-driven analytics.

Each fragrance product profile is stored as a structured dataset within the database 108, capturing multiple fragrance profiling categories. The processor 102 extracts, encodes, and organizes fragrance attributes into a multi-dimensional digital barcode representation, ensuring consistency and scalability.

In an embodiment, each Product Barcode consists of a plurality of profiling categories corresponding to consumer perception and scent attributes such as:
Scent Style—Floral, Woody, Fresh, Spicy, Oriental, Gourmand, etc.
Main Fragrance Note—Vanilla, Musk, Amber, Citrus, Sandalwood, etc.
Mood Association—Romantic, Calming, Energizing, Sensual, Mystical, etc.
Seasonal Suitability—Summer, Winter, Spring, Autumn.
Occasion-Based Relevance—Office, Casual, Party, Special Events, Date Night.
Target Age Group—18-25, 26-35, 36-50, 50+.
Smell Intensity—Light, Moderate, Strong.
Longevity Expectation—Short-lasting (2-4 hrs), Medium-lasting (4-8 hrs), Long-lasting (8+ hrs).
Best Time to Wear—Morning, Afternoon, Evening, Night.
Bottle Design Appeal—Classic, Minimalist, Luxurious, Futuristic.

Each attribute category is weighted based on its importance in the consumer decision-making process, ensuring that the processor can accurately compare Product Barcodes with Personal Barcodes.

When a new fragrance is added to the database 108, the processor 102 extracts structured product data from brand catalogues, retailer databases, and manufacturer descriptions and assigns default attribute values to establish an initial Product Barcode based on predefined scent classification datasets. In an embodiment, the processor 102 conducts A/B testing by exposing new fragrances to a pilot group of users and aggregates early user feedback and preference trends to refine the initial barcode encoding.

The processor 102 utilizes natural language processing (NLP) and machine learning algorithms to analyze product reviews, user comments, and purchase history. The processor 102 is further operable to identify implicit patterns (e.g., users who prefer “Fresh” scents often like “Citrus” notes) and dynamically adjusts initial classification values based on sentiment analysis and statistical correlations. The processor 102 is operable to convert fragrance attributes into a color-coded barcode representation, where:
Color variations represent dominant scent profiles.
Segment lengths indicate popularity distribution across different user demographics.

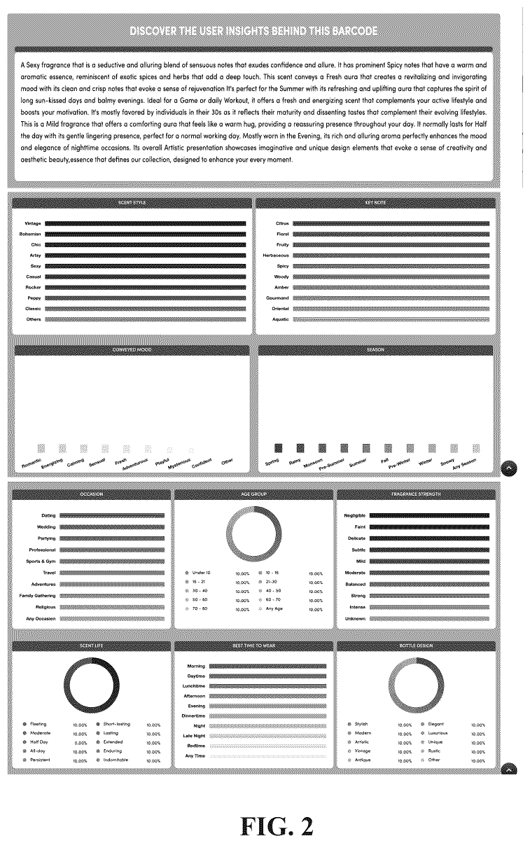

FIG. 2 depicts an example product profile page 200 related to a fragrance.

The processor 102 is operable to stores the finalized Product Barcode in the database 108, allowing real-time retrieval and AI-driven recommendation matching.

Unlike static product descriptions, each Product Barcode evolves dynamically, ensuring fragrance recommendations remain adaptive to shifting consumer preferences and market trends. The processor 102 continuously updates the database 108 by aggregating insights from multiple real-world and digital data sources, including user interactions with recommendations (e.g., like/dislike, save to favourites, purchase history) and explicit user-provided ratings on intensity, longevity, and scent appeal. Furthermore, the processor 102 scrapes and analyses e-commerce reviews, fragrance blogs, and forums. The processor 102 assigns new weightage to fragrance attributes based on user-generated insights. As an example, if 60% of users say a fragrance lasts longer than advertised, its longevity score is increased.

Further, the processor 102 analyses conversion rates from recommendations to purchases and detects trends in frequently returned scents, refining the barcode to better match consumer expectations. In an embodiment, the processor 102 is further operable to identify rising fragrance trends based on social media sentiment analysis and industry reports and also recognizes seasonal shifts in user preferences (e.g., citrus-based scents in summer see higher demand) and based on said emerging trends identities, adjusts product classifications. As an example, a woody fragrance might be re-ranked as a top recommendation in autumn months.

Moreover, the processor 102 is operable to detect cross-product correlations, ensuring that similar products receive cohesive updates. As an example, if users who prefer Floral scents start gravitating toward Oriental fragrances, the processor 102 reclassifies overlapping attributes. The processor 102 utilizes adaptive machine learning algorithms to adjust Product Barcodes dynamically, ensuring that the fragrance characteristics evolve in sync with user behaviour and global industry trends.

Based on the real time changes in the product perceptions by the users as described above, the visual representation of Product Barcodes changes in real-time as well More dominant colours appear based on trending scent attributes and segment lengths shift dynamically to reflect category popularity.

In an embodiment, the processor 102 is integrated with e-commerce platforms, and the updated product profiles are synchronized via API, ensuring that retailers display the most up-to-date fragrance classifications.

The processor 102 receives user preference data through the remote graphical user interface (GUI) 106 that interacts with the processor 102 over a data communication network 110, such as the internet or a cloud-based API infrastructure. The GUI 106 operates on client-side devices, including web browsers, mobile applications, or embedded systems within e-commerce platforms. The data transmission follows secure network protocols (e.g., HTTPS, RESTful API calls, WebSockets) to ensure real-time, encrypted, and authenticated communication between the user and the system.

The GUI 106 presents an interactive questionnaire designed to capture comprehensive fragrance preferences of a user associated with the GUI. The questionnaire consists of structured multiple-choice questions, dropdown selections, and preference sliders covering multiple fragrance profiling categories, including but not limited to:
Scent Style: Floral, Woody, Fresh, Spicy, Oriental, Gourmand, Aquatic, etc.
Main Fragrance Note: Lavender, Sandalwood, Citrus, Vanilla, Musk, etc.
Mood Preference: Energizing, Relaxing, Romantic, Mysterious, Elegant, etc.
Seasonal Suitability: Summer, Winter, Spring, Autumn.
Occasion-Based Selection: Daily Wear, Office, Party, Special Event, Date Night.
Age Group Relevance: 18-25, 26-35, 36-50, 50+.
Smell Intensity Preference: Light, Moderate, Strong.
Longevity Expectation: Short-lasting (2-4 hrs), Medium lasting (4-8 hrs), Long-lasting (8+ hrs).
Best Time to Wear: Morning, Afternoon, Evening, Night.
Bottle Presentation Appeal: Minimalist, Luxury, Artistic, Classic, Futuristic

In an embodiment, each response from the user is processed locally on the client side, where initial data validation is performed to ensure user selections are complete and formatted correctly. In another embodiment, the response is processed by the processor 102 on the server side to validate the user selections.

The response comprising the user preferences are structured into a standard format to ensure compatibility across different devices and platforms. The GUI 106 transmits the collected preference data to the processor 102 over the data communication network 110.

Upon receiving structured user preference data from the graphical user interface (GUI) 106, the processor 102 extracts, normalizes, and encodes the data into a Personal Barcode. The user preference data consists of multiple fragrance profiling categories as per the questionnaire. Each user selects and prioritizes preferences within these categories, forming the raw dataset for generating the Personal Barcode.

The Personal Barcode is structured as a multi-dimensional data vector, encoding user preferences in a numerical, weighted format that allows AI-based analysis and recommendation.

In an aspect of the present invention, the processor 102 is operable to normalize the inputs and assign weights to fragrance attributes (user-selected preferences). User preferences are converted into numerical values on a standardized scale (e.g., 0 to 1 or weighted ranking from 1 to 100). Text-based inputs (e.g., scent style=Floral, mood=Romantic) are mapped to predefined vectors in a fragrance classification ontology. If a user strongly prefers floral fragrances, the “Floral” category receives a weight of 0.95, while less preferred categories may receive weights between 0.2 to 0.5. The normalized and weighted scent preference data is encoded into a unique digital identifier, forming the Personal Barcode.

In an embodiment, the Personal Barcode may be structured as a multi-segment numerical vector (e.g., [0.95, 0.7, 0.3, 0.85, 0.4, 0.2, 0.6, 0.9]) or a visual barcode representation with color-coded segments and variable segment lengths, corresponding to dominant fragrance attributes.

The Personal Barcode evolves over time as users interact with recommendations (e.g., liking/disliking suggestions, updating preferences). The processor 102 continuously refines the barcode based on user engagement metrics (e.g., purchase behaviour, review feedback) and contextual factors (e.g., seasonal trends, emerging fragrance preferences). If a user updates their preferences via the GUI 106, the processor 102 recalculates the Personal Barcode in real time. As an example, if a user previously preferred “Citrus” scents but later shifts to “Woody” preferences, the barcode structure is reweighted to reflect the new dominant fragrance profile.

In an aspect of the present invention, the processor 102 matches the Personal Barcode with one or more Product Barcodes using an Artificial Intelligence (AI) engine, wherein the AI engine applies similarity analysis based on shared attributes and user preference weighting across fragrance profiling categories. Additionally, the AI engine continuously refines the matching process by learning from user interactions and adapting to evolving user preferences and global fragrance trends. In an embodiment, the AI engine is incorporated within the processor 102. Optionally, the AI engine can be a separate module communicably coupled with the processor 102. References to AI engine and the processor shall be used interchangeably for the purpose of describing the matching operations of product and personal barcodes.

The AI engine receives the Personal Barcode, a unique scent profile identifier generated from user preferences, and performs a similarity analysis against a database of Product Barcodes, which represent fragrance products. The AI engine 110 computes similarity scores by analysing shared attributes between the Personal Barcode and Product Barcodes, considering the following factors:
Scent Composition Matching: Identifies overlapping fragrance notes between the user's preferred scent profiles and stored Product Barcodes.
Preference Weighting: Gives higher priority to attributes explicitly marked as important by the user (e.g., if a user prioritizes “Woody” scents, products with dominant woody notes receive a higher score).
Occasion & Season Relevance: Ensures fragrance recommendations align with user-stated seasonal preferences and intended usage occasions.
Intensity & Longevity Alignment: Matches fragrances based on the user's desired smell intensity and longevity expectations.

Described below is an example matching process as per an example embodiment of the present invention.

The Personal Barcode encodes:
Floral (Weight: 0.85)
Woody (Weight: 0.70)
Moderate Intensity (Weight: 0.90)
Office Wear (weight: 0.60)
   The AI engine compares the Personal Barcode against stored Product Barcodes:
Product A (Similarity Score: 92%)→Matches floral, woody, and moderate intensity.
Product B (Similarity Score: 81%)→Matches floral but has high intensity (user prefers moderate).
Product C (Similarity Score: 75%)→Matches occasion but has lower scent longevity.
   The highest-ranked products are included in the final fragrance recommendation list.

In another aspect of the present invention, the AI engine 110 continuously improves the matching accuracy by learning from user interactions and adapting to evolving fragrance preferences and global trends. The AI engine 110 monitors user interactions with the recommended fragrances, including Likes/Dislikes (explicit preference indicators), Click-through and engagement rates (e.g., viewing a product multiple times suggests interest), Purchase decisions & return rates (successful purchases indicate correct matching), and User modifications to Personal Barcode (adjustments reflect evolving preferences). If a user frequently rejects certain fragrance recommendations, the AI adjusts preference weightings accordingly.

In another aspect of the present invention, the processor 102 generates personalized fragrance recommendations, wherein the recommendations are based on the AI-determined matching between the digital scent profile identifier (Personal Barcode) and the product profiles (Product Barcodes).

Once the AI engine 110 processes the Personal Barcode and matches it with one or more Product Barcodes, the processor 102 retrieves the ranked list of best-matching fragrances using a ranking algorithm. The ranking is determined by Similarity Score-Based Prioritization, User Interaction Data Influence and Contextual Adjustments for Seasonality & Mood. Higher similarity scores between the Personal Barcode and Product Barcodes lead to higher ranking in the recommendation list. The top recommendations (e.g., 90%+ match) are highlighted as best-fit options. Further, the processor 102 learns from prior user interactions, ensuring better refinement over time. If the user frequently engages with floral scents, the system prioritizes those matches in future recommendations. The processor 102 adjusts recommendations based on current season and user mood settings. If a user sets their mood to “Relaxing”, the system prioritizes lavender and sandalwood-based scents.

The processor 102 displays the one or more personalized fragrance recommendations on the graphical user interface 106. For each of the fragrances from the one or personalized fragrance recommendations, a fragrance identity information comprising Brand and product name, Concentration type (Eau de Toilette, Eau de Parfum, Perfume Extract) and Fragrance family classification (Floral, Oriental, Woody, Fresh, etc.) is displayed alongside. Further, the processor 102 is operable to display a decision basis for the said matched fragrance wherein the decision basis comprises a numerical similarity percentage (e.g., 92% match based on shared attributes), dominant scent attributes that contributed to the match (e.g., “Vanilla & Amber” notes match user preference) and weight distribution across fragrance profiling categories (e.g., 70% Mood-Based, 20% Seasonal, 10% Longevity).

A graphical representation of the fragrance profile including Color-coded and segmented visualization showing prominent fragrance notes, scent longevity, and intensity is displayed on the graphical user interface.

In an embodiment, the processor 102 allows the user to dynamically modify their preferences and instantly regenerate fragrance suggestions. Users can manually adjust their scent preferences, prompting the processor 102 to recompute suggestions in real time. As an example, if the user moves the slider for “Intensity” from Moderate to Strong, the processor 102 immediately updates recommendations.

In yet another embodiment, users can rate recommendations, allowing the processor 102 to retrain its ranking model. As an example, if a user dislikes a recommendation, the system reduces weightage for that fragrance category in future matches.

In another embodiment, the processor 102 includes a “Find Similar Scents” feature, allowing users to explore adjacent fragrance categories. If a user likes a recommended scent, they can view similar fragrances based on overlapping Product Barcode attributes.

Optionally, the processor 102 is operable to integrate with third-party e-commerce platforms, enabling users to receive and interact with personalized fragrance recommendations across multiple online stores. This integration ensures that AI-driven fragrance recommendations are seamlessly accessible within digital retail environments, providing users with an intelligent, data-driven shopping experience.

Optionally, retailers and third-party e-commerce applications can embed recommendation widgets that dynamically display user-specific fragrance matches. If the user is logged into an e-commerce account, the processor 102 automatically loads their Personal Barcode and retrieves fragrance recommendations.

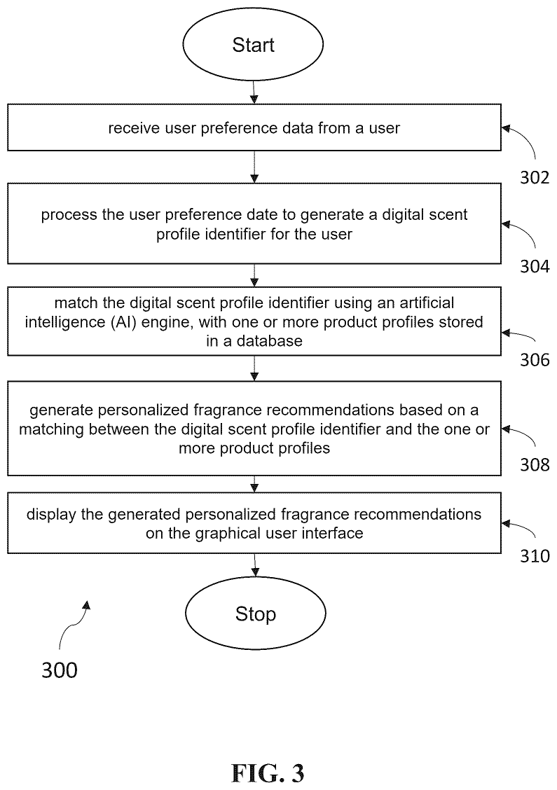

FIG. 3 is a flowchart depicting the method steps 300 of the invention as disclosed herein. At step 302, the processor receives user preference data from a user. This data is collected by presenting a structured questionnaire on a graphical display unit 106 associated with a user client. At step 304, the user preference data is processed to generate a digital scent profile identifier for the user. At step 306, the digital scent profile identifier is matched, using an artificial intelligence (AI) engine, with one or more product profiles stored in a database 108 using a similarity analysis based on shared attributes and user preference weighting across the fragrance profiling categories. At step 308, personalized fragrance recommendations are generated based on a matching between the digital scent profile identifier and the one or more product profiles wherein the personalized fragrance recommendations comprise a ranked list of fragrances. At step 310, generated personalized fragrance recommendations are displayed the on the graphical user interface 106.

The data communication network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of the foregoing.

As described herein, the processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a controller using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

One or more components of the invention are described as unit or modules for the understanding of the specification. For example, a unit may include self-contained component in a hardware circuit comprising of logical gate, semiconductor device, integrated circuits or any other discrete component. The unit may also be a part of any software programme executed by any hardware entity for example processor. The implementation of unit as a software programme may include a set of logical instructions to be executed by a processor or any other hardware entity.

Additional or less units can be included without deviating from the novel art of this disclosure. In addition, each unit can include any number and combination of sub-units, and systems, implemented with any combination of hardware and/or software units.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for providing personalized fragrance recommendations, comprising:
a processor coupled to one or more data communication network:
a memory operatively coupled to the processor, the memory storing instructions that, when executed by the processor, configure the processor to:
receive, from a user, user preference data from a graphical user interface (GUI) over a data communication network, wherein the GUI presents an interactive questionnaire corresponding to multiple fragrance profiling categories;
generate a digital scent profile identifier based on the user preference data, wherein the digital scent profile identifier represents the user's unique olfactory preferences;
match the digital scent profile identifier with one or more product profiles using an artificial intelligence (AI) engine, wherein the AI engine applies similarity analysis based on shared attributes and user preference weighting across the fragrance profiling categories;
generate personalized fragrance recommendations based on a matching between the digital scent profile identifier and the one or more product profiles wherein the personalized fragrance recommendations comprise a ranked list of fragrances; and
display the personalized fragrance recommendations on the graphical user interface.

2. The system of claim 1 wherein the processor is configured to store the one or more product profiles for a plurality of fragrances in a database, wherein each of the one or more product profiles is dynamically updated based on real-time global user feedback and includes fragrance characteristics corresponding to the fragrance profiling categories.

3. The system of claim 1, wherein the processor is further configured to enable the user to update, via the graphical user interface, the digital scent profile identifier in real-time.

4. The system of claim 1, wherein the AI engine is further configured to continuously refine the matching process by learning from user interactions and adapting to evolving user preferences and global fragrance trends.

5. The system of claim 1, wherein the database stores product profiles represented using a color-coded visual indicator comprising variable length segments, and the length of each segment corresponds to the relative popularity of a specific attribute within the fragrance profiling categories.

6. The system of claim 1, further comprising a similarity-based fragrance discovery tool configured to allow the user to explore fragrances with product profiles similar to the digital scent profile identifier or past selections.

7. The system of claim 1, wherein the processor is further configured to display, on the graphical user interface, a detailed breakdown, for each product profile, including the percentage distribution of user feedback for each fragrance profiling category.

8. The system of claim 1, wherein the processor is further configured to prioritize fragrance recommendations based on contextual factors as derived from the digital scent profile identifier.

9. The system of claim 1, wherein the processor is integrated with an e-commerce platform, and the personalized fragrance recommendations are dynamically displayed on the profile page or shopping interface, associated with the user, of the e-commerce platform.

10. The system of claim 1, wherein the processor is further configured to match the digital scent profile identifier with product profiles using a weighted scoring system, wherein fragrance profiling categories are assigned different priority levels based on user preferences and contextual factors.

11. A method for providing personalized fragrance recommendations, comprising:
receiving user preference data from a graphical user interface (GUI) over a data communication network, the GUI presenting a questionnaire comprising questions corresponding to multiple fragrance profiling categories;
processing the user preference data to generate a digital scent profile identifier, wherein the digital scent profile identifier represents the user's unique olfactory preferences;
matching the digital scent profile identifier with one or more product profiles using an artificial intelligence (AI) engine, wherein the AI engine applies similarity analysis based on shared attributes and user preference weighting across the fragrance profiling categories;
generating personalized fragrance recommendations based on a matching between the digital scent profile identifier and the one or more product profiles wherein the personalized fragrance recommendations comprise a ranked list of fragrances;
displaying the personalized fragrance recommendations on the graphical user interface.

12. The method of claim 11 wherein the processor is configured to store the one or more product profiles for a plurality of fragrances in a database, wherein each of the one or more product profiles is dynamically updated based on real-time global user feedback and includes fragrance characteristics corresponding to the fragrance profiling categories.

13. The method of claim 11 wherein the processor is further configured to enable the user to update, via the graphical user interface, the digital scent profile identifier in real-time.

14. The method of claim 11 wherein the processor is further configured to continuously refine the matching process by learning from user interactions and adapting to evolving user preferences and global fragrance trends.

15. The method of claim 11 wherein the database stores product profiles represented using a color-coded visual indicator comprising variable length segments, and the length of each segment corresponds to the relative popularity of a specific attribute within the fragrance profiling categories.

16. The method of claim 11 further comprising a similarity-based fragrance discovery tool configured to allow the user to explore fragrances with product profiles similar to the digital scent profile identifier or past selections.

17. The method of claim 11 wherein the processor is further configured to display, on the graphical user interface, a detailed breakdown, for each product profile, including the percentage distribution of user feedback for each fragrance profiling category.

18. The method of claim 11 wherein the processor is further configured to prioritize fragrance recommendations based on contextual factors as derived from the digital scent profile identifier.

19. The method of claim 11 wherein the processor is integrated with an e-commerce platform, and the personalized fragrance recommendations are dynamically displayed on the profile page or shopping interface, associated with the user, of the e-commerce platform.

20. The method of claim 11 wherein the processor is further configured to match the digital scent profile identifier with product profiles using a weighted scoring system, wherein fragrance profiling categories are assigned different priority levels based on user preferences and contextual factors.
